(19) United States
(12) Patent Application Publication
(10) Pub. No.: US 2026/0141572 A1
(43) Pub. Date: May 21, 2026

(54) ATTENTION CONTRAST-AND-COMPLETE FOR INITIAL NOISE OPTIMIZATION IN TEXT-TO-IMAGE SYNTHESIS

(71) Applicant: ADOBE INC., SAN JOSE, CA (US)

(72) Inventors: Aravindan Kamatchi Sundaram, Chennai (IN); Ujjayan Pal, West Tripura (IN); Abhimanyu Chauhan, Moradabad (IN); Aishwarya Agarwal, Bangalore Karnataka (IN); Srikrishna Karanam, Bengaluru Karnataka (IN)

(21) Appl. No.: 18/950,718

(22) Filed: Nov. 18, 2024

(51) Int. Cl. G06T 11/00

(52) U.S. Cl. CPC G06T 11/00

(57) ABSTRACT

A method, apparatus, non-transitory computer readable medium, and system for generating synthetic image includes obtaining an input prompt describing a first element and a second element. In some cases, an image generation model generates an intermediate output based on the input prompt and optimizes the intermediate output based on an attention contrast loss to obtain an optimized intermediate output. For example, the optimized intermediate output represents the first element at a first location and the second element at a second location. The image generation model generates a synthetic image based on the optimized intermediate output. The synthetic image depicts the first element at the first location and the second element at the second location.

### BACKGROUND

The following relates generally to image processing, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model may be trained to predict information in response to an input prompt, and to then generate an output based on the predicted information. In some cases, the prompt can be used to perform a complex manipulation and compositing. The generated output provides for a user to edit or generate an image with desired features and therefore makes image generation easier for a layperson and also more readily automated.

### SUMMARY

The present disclosure describes systems and methods for image processing, more specifically to image generation using an input prompt. Embodiments of the present disclosure include an image generation model configured to determine an optimal latent noise from an initial latent noise. In some cases, the image generation model is configured to optimize the initial latent noise using a loss function computed based on a self-attention map and a cross-attention map corresponding to an element described in the input prompt. For example, the optimized latent noise is incorporated into a diffusion network and denoised to generate an image that accurately aligns with the input prompt.

A method, apparatus, and non-transitory computer readable medium for image processing are described. One or more aspects of the method, apparatus, and non-transitory computer readable medium include obtaining an input prompt describing a first element and a second element; generating, using an image generation model, an intermediate output based on the input prompt; optimizing the intermediate output based on an attention contrast loss to obtain an optimized intermediate output, wherein the optimized intermediate output represents the first element at a first location and the second element at a second location; and generating, using the image generation model, a synthetic image based on the optimized intermediate output, wherein the synthetic image depicts the first element at the first location and the second element at the second location.

A method, apparatus, and non-transitory computer readable medium for image processing are described. One or more aspects of the method, apparatus, and non-transitory computer readable medium include obtaining an input prompt indicating a first element and a second element; generating, using an image generation model, an intermediate output based on the input prompt; updating a statistical property such as mean and a covariance of the intermediate output to obtain an optimized intermediate output, wherein the optimized intermediate output represents the first element and the second element; and generating, using the image generation model, a synthetic image depicting the first element and the second element based on the optimized intermediate output.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image generation process according to aspects of the present disclosure.

FIG. 4 shows an example of an image generation model with an attention layer according to aspects of the present disclosure.

FIG. 5 shows an example of a latent diffusion architecture according to aspects of the present disclosure.

FIG. 6 shows an example of an image generation model according to aspects of the present disclosure.

FIG. 7 shows an example of a U-Net architecture according to aspects of the present disclosure.

FIG. 8 shows an example of a denoising diffusion process according to aspects of the present disclosure.

FIG. 9 shows an example of a method for image processing according to aspects of the present disclosure.

FIG. 10 shows an example of a method for computing an attention contrast term according to aspects of the present disclosure.

FIG. 11 shows an example of a method for computing an attention complete term according to aspects of the present disclosure.

FIG. 12 shows an example of a method for training a machine learning model according to aspects of the present disclosure.

FIG. 13 shows an example of a method for training a diffusion model according to aspects of the present disclosure.

FIG. 14 shows an example of a computing device according to aspects of the present disclosure.

FIG. 15 shows an example of an image processing apparatus according to aspects of the present disclosure.

FIG. 16 shows an example of a machine learning model according to aspects of the present disclosure.

### DETAILED DESCRIPTION

Image generation systems attempt to implement methods including prompt engineering, finetuning/reinforcement learning strategies, etc. for image generation. However, such systems are unable to generate images that accurately align with an input prompt. For example, existing image generation systems generate images that are misaligned with the input prompt or generate images that omit an element or depict mixed-up elements. In some examples, such systems generate images depicting an element with properties from another element, e.g., the generated image may include a bear with rabbit-like ears or may include a dolphin with turtle-like fins and/or mouth. Moreover, such systems may generate images with missing elements, such as a missing rabbit even when the input prompt describes a rabbit.

In some cases, existing image generation systems generate self-attention maps and cross-attention maps corresponding to an element in the generated image. However, in some examples, an activated region in the cross-attention map of an element attends to an overlapping region in a self-attention map of another element. As a result, the generated image depicts an element with properties from another element (i.e., attention interference). In some cases, the self-attention map depicts a missing segment, e.g., when an input prompt includes two elements but the image generation system generates one contiguous self-attention segment. The inaccuracy in generation of the self-attention segment results in the cross-attention map of each element attending to the same self-attention region which causes a missing element in the generated image (i.e., attention neglect).

Additionally, existing image generation systems are trained using relatively limited computational resources which results in a lack of flexibility due to model retraining. In some cases, such systems include restricted availability of denoising timesteps necessary for the convergence of losses. Moreover, such systems may depict an out-of-distribution shifts when iteratively refining the latent codes. Accordingly, existing systems lack an ability to generate an image that accurately aligns with the input prompt.

By contrast, the present disclosure describes systems and methods for image processing, more specifically for accurate image generation using an input prompt. Embodiments of the present disclosure include an image generation model configured to determine an optimal latent noise which is incorporated into a diffusion network and denoised to generate an image that accurately aligns with the input prompt (e.g., input text prompt). In some cases, the image generation model is configured to optimize an initial latent noise using a combined loss function based on a self-attention map and a cross-attention map corresponding to an element described in the input prompt.

According to an embodiment, the image generation model is configured to optimize the initial latent vector by computing the combined loss function comprising an attention contrast loss term and an attention complete loss term. In some cases, the image generation model is configured to minimize or prevent occurrence of a missing element by ensuring a high-response self-attention segment for each element. Additionally, the image generation model is configured to minimize or prevent occurrence of mixed-up elements by minimizing interference between the cross-attention map for an element with the self-attention segment of another element.

The image generation model of the present disclosure implements an algorithm that optimizes an initial latent noise by leveraging complementary information within self-attention maps and cross-attention maps associated with the elements. In some cases, the image generation model computes the combined loss function comprising the attention contrast loss term and the attention complete loss term within a noise optimization framework. For example, the attention contrast loss term is configured to minimize undesirable overlap by ensuring a self-attention segment is exclusively linked to a cross-attention map of an element. Additionally, for example, the attention complete loss term is configured to maximize the activation within the segment resulting in a complete and distinct representation of an element provided by the input prompt.

An exemplary embodiment of the present disclosure includes an image generation model configured to generate an image based on an input prompt and a corresponding cross-attention map and a self-attention map based on an element described in the input prompt. In some examples, the image generation model of the present disclosure generates a mapping between the cross-attention map of an element and a corresponding segment obtained from the self-attention map. As a result, the self-attention map is assigned to the element.

In some examples, the attention complete loss term is configured to maximize the cross-attention activation of an element within the assigned self-attention segment. In some cases, each element token of the plurality of element tokens is assigned to a high-response segment in the self-attention map which ensures the presence of each element provided in the input prompt. In some examples, the attention contrast loss term is configured to minimize the overlap between the cross-attention map of the element and the self-attention segments of another element provided in the input prompt which results in reduction of the inter-subject confusion in the attention space.

In some examples, the combined loss function is computed based on a weighted sum of the attention complete loss term, the attention contrast loss term, and a Kullback-Leibler divergence (KLD) loss term. For example, the KLD loss term is incorporated in the combined loss function to ensure the distribution of the optimized latent vector is close to the standard normal distribution.

According to an example, the image generation model is configured to randomly sample an initial latent code. In some cases, a mean and a covariance of the initial latent code are initialized as zero and one, respectively. The image generation model optimizes the initial latent code by repeatedly performing (e.g., performing until convergence) a denoising process (e.g., a single denoising step) based on updated values of the mean and the covariance, wherein each of the mean and the covariance values are updated based on the combined loss function.

Embodiments of the present disclosure are configured to perform an initial latent optimization based on identifying an attention neglect and attention interference. In some cases, the image generation model of the present disclosure is configured to compute a combined loss function comprising an attention complete loss term and an attention contrast loss term to prevent occurrence of the identified attention neglect and attention interference, respectively. For example, the attention complete loss term is configured to ensure each element in the input prompt has a self-attention segment and the attention contrast loss term is configured to ensure the cross-attention map of an element does not overlap the self-attention of another element.

Accordingly, by computing the combined loss function within the noise optimization framework, embodiments of the present disclosure are able to prevent retraining of the base diffusion network. Additionally, by incorporating the combined loss function to optimize the initial latent vector of the diffusion network and denoising the optimized latent vector with the diffusion network, embodiments of the present disclosure are able to generate images that are meaningful and that accurately align with the input prompt.

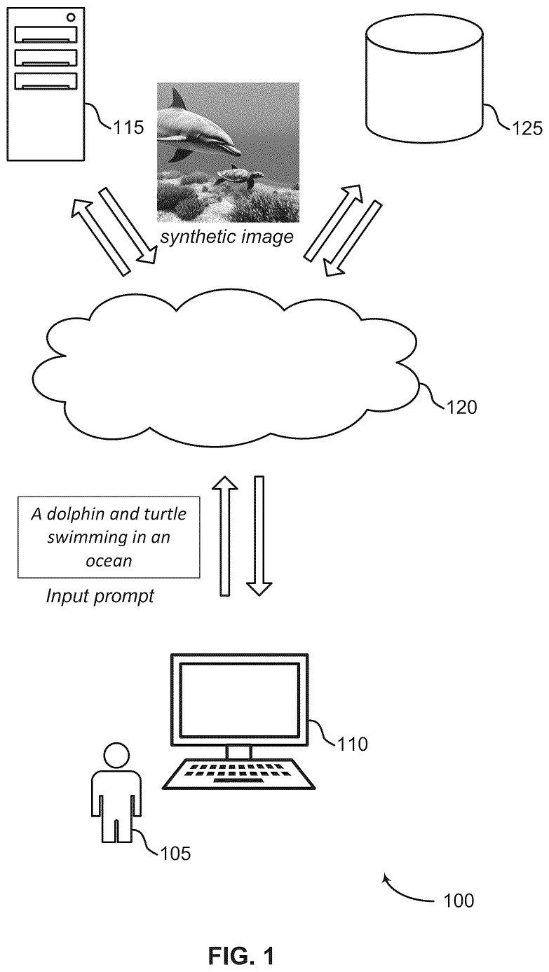

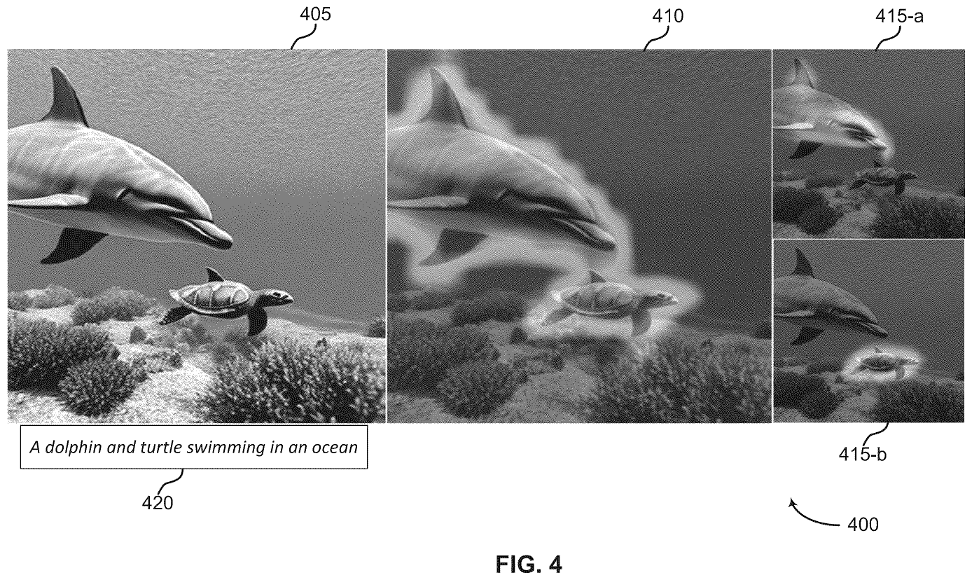

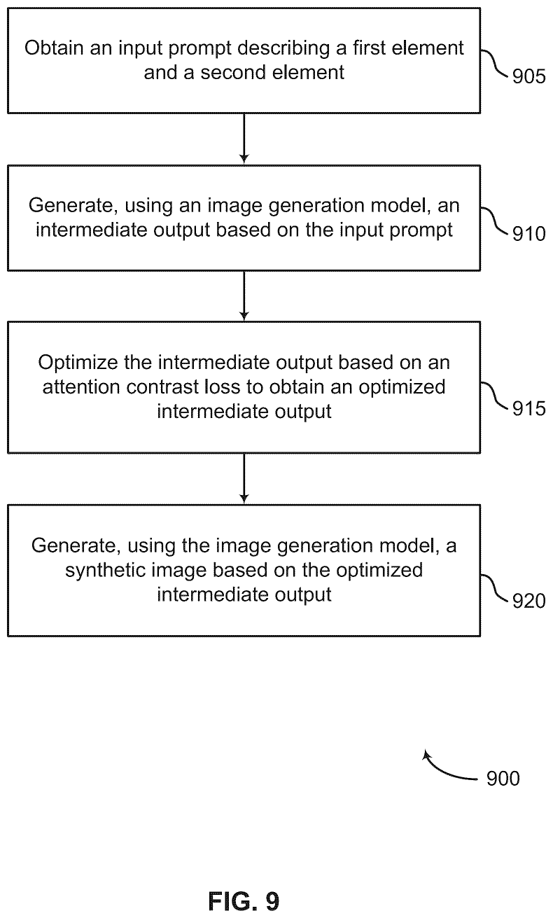

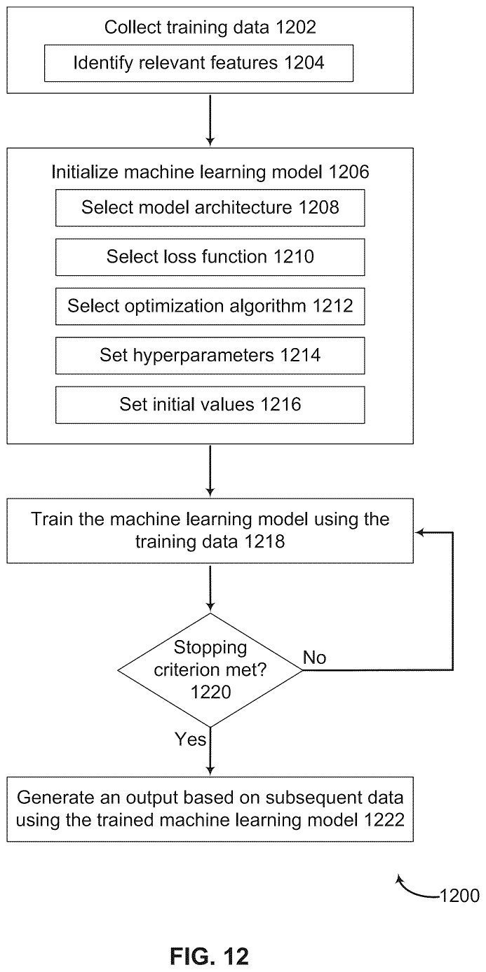

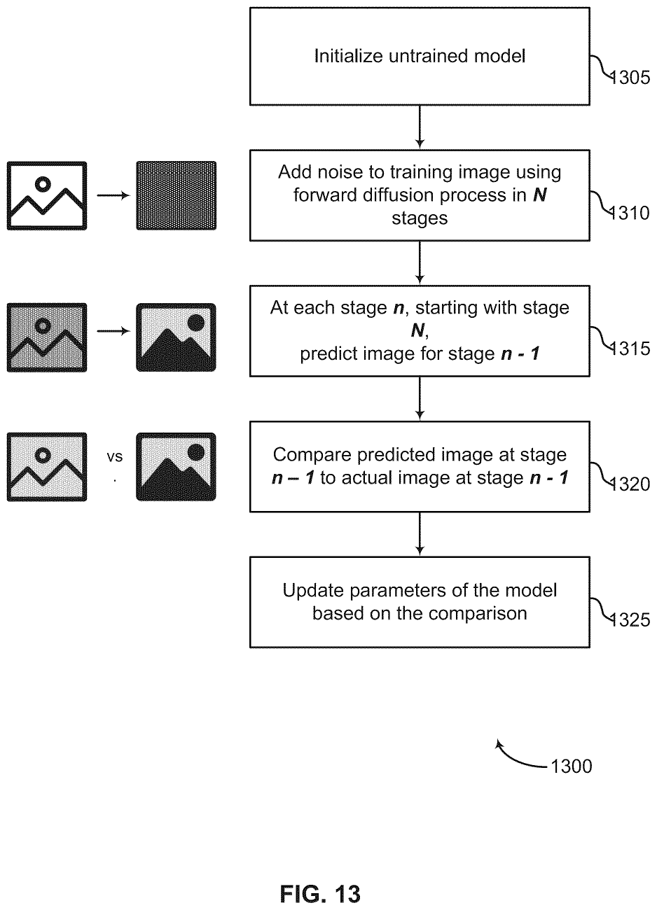

Embodiments of the present disclosure can be implemented in an image generation model. For example, the image generation model based on the present disclosure takes an input prompt (e.g., describing an element) and generates an output image that accurately depicts the element described in the prompt. Example applications regarding generating an output that depicts an element are provided with reference to FIGS. 1-3. Details regarding the architecture of the image generation model are provided with reference to FIGS. 4-8 and 14-16. Details regarding an operation of the image generation model are provided with reference to FIG. 9-11. Examples of a process for training the image generation model are provided with reference to FIGS. 12-13.

### Image Generation System

A system and an apparatus for image processing are described with reference to FIGS. 1-8. FIG. 1 shows an example of an image processing system 100 according to aspects of the present disclosure. In one aspect, an image processing system 100 includes user 105, user device 110, image processing apparatus 115, cloud 120, and database 125.

In the example of FIG. 1, user 105 provides a prompt describing an element (e.g., a plurality of elements) to image processing apparatus 115 via a user interface provided on user device 110 by image processing apparatus 115. In some cases, the input prompt is an input text. As shown in FIG. 1, the input prompt describes an element based on which the user wants to generate a synthetic image using the image processing apparatus 115 of the present disclosure. According to some aspects, the image processing apparatus 115 obtains an input prompt, i.e., describing a plurality of elements in a scene.

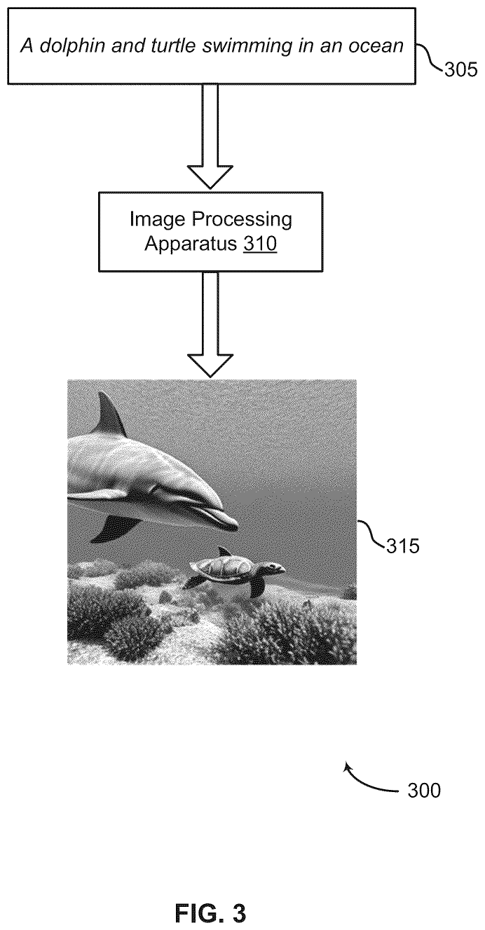

In some cases, the image processing apparatus 115 implements an image generation model (such as the image generation model described with reference to at least FIGS. 4, 6, and 9-11) to generate a synthetic image that is based on the input prompt. In some cases, as shown in FIG. 1, the user provides an input prompt (e.g., a text prompt) to the image processing apparatus 115, aspects of which the user wants to depict in the synthetic image. In some examples, the image processing apparatus generates a synthetic image that accurately aligns with the information provided by the input prompt. Image processing apparatus 115 is an example of, or includes aspects of, the corresponding element described with reference to FIG. 3.

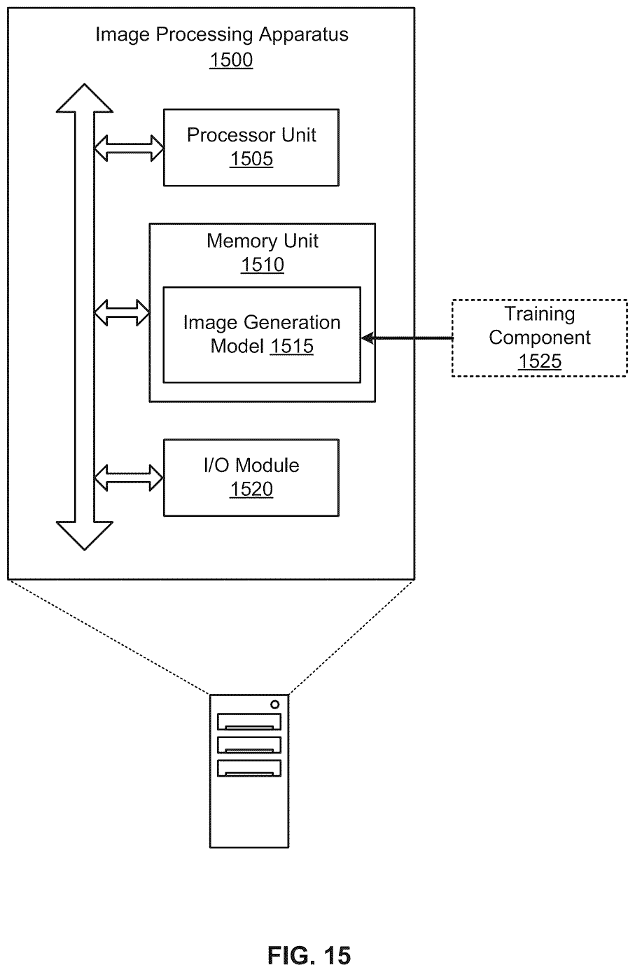

Referring to the example of FIG. 1, the image processing apparatus 115 generates the synthetic image that accurately depicts each aspect (e.g., element) described by the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIG. 15.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

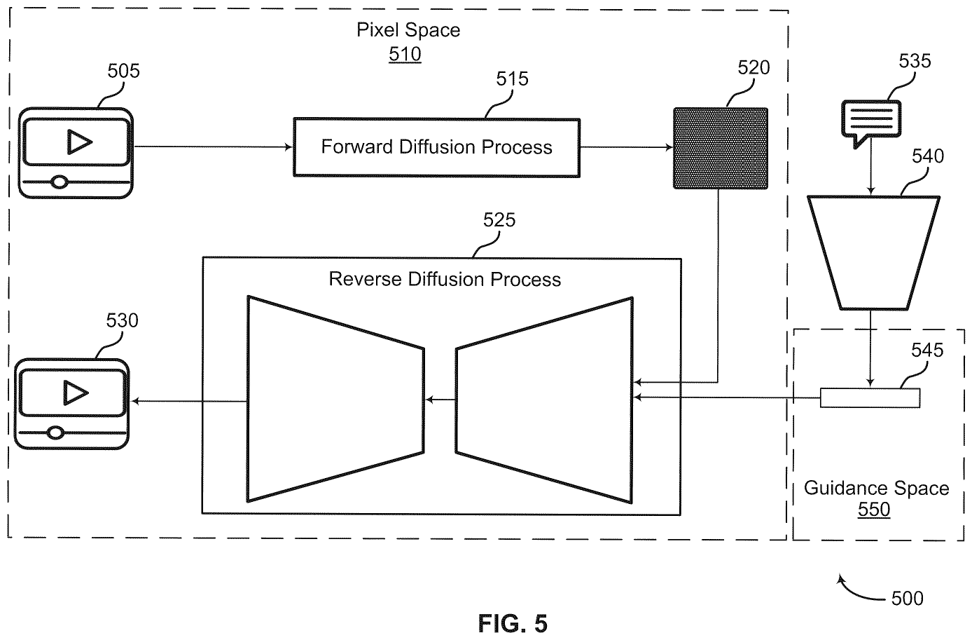

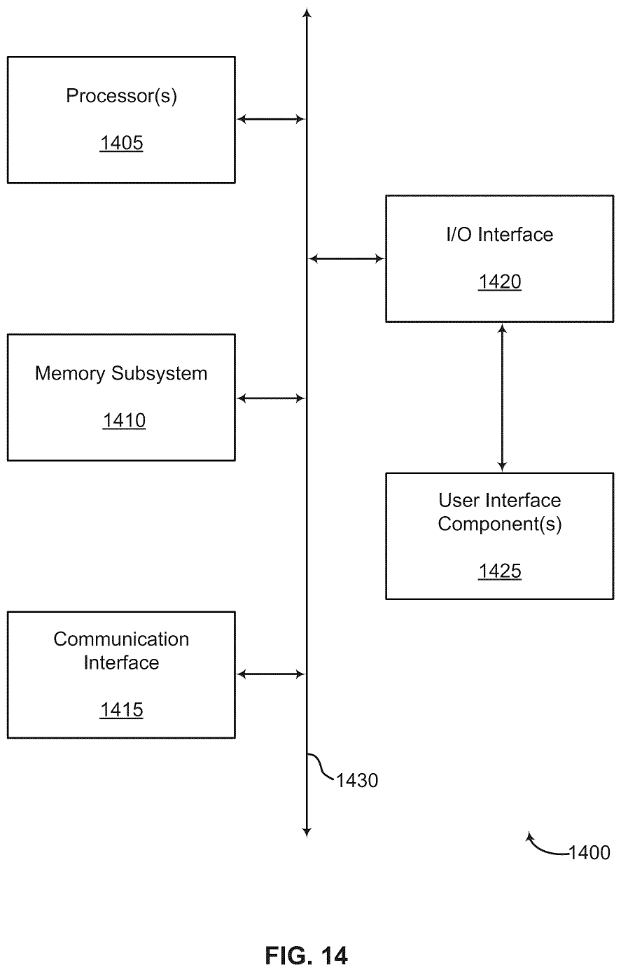

According to some aspects, image processing apparatus 115 includes a computer-implemented network. In some embodiments, the computer-implemented network includes a machine learning model (such as the image generation model described with reference to FIGS. 5-8). In some embodiments, image processing apparatus 115 also includes one or more processors, a memory subsystem, a communication interface, an I/O interface, one or more user interface components, and a bus as described with reference to FIG. 14. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

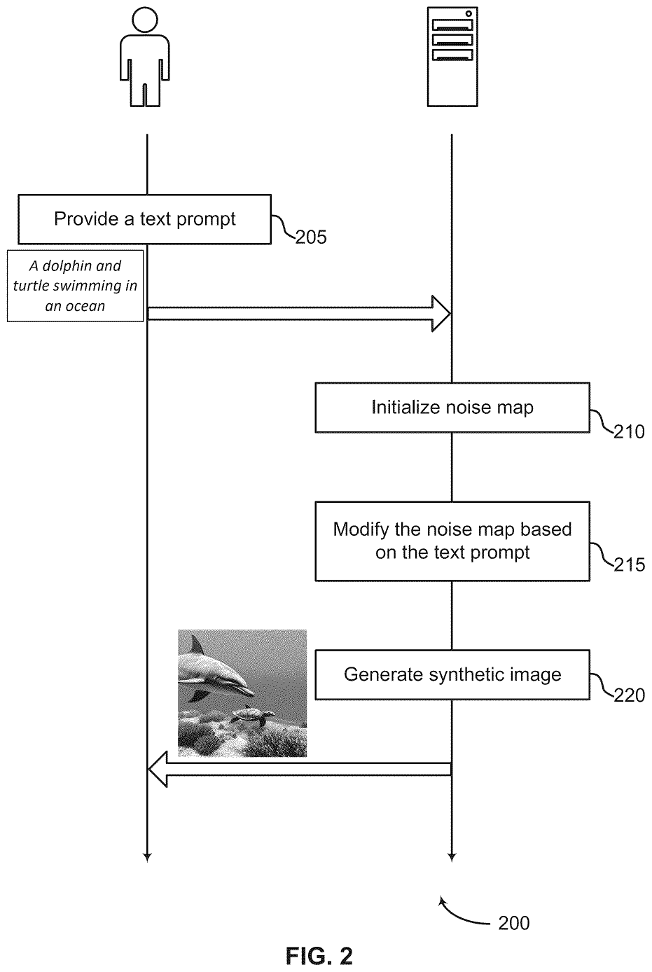

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIGS. 3 and 12) provides an image generation model (such as the image generation model described with reference to FIGS. 4-8 and 15-16) that accurately generates a synthetic image depicting the elements described in the input text prompt.

At operation 205, the system provides a text prompt. In some cases, the operations of this step refer to, or may be performed by, a user as described with reference to FIG. 1. Additionally, the user provides a prompt to the image processing apparatus. In some cases, the prompt is a text prompt that provides an instruction based on which the user wants to generate an image. For example, the user provides an input prompt instructing the image processing apparatus to generate an image with “A dolphin and turtle swimming in an ocean”.

At operation 210, the system initializes a noise map. In some cases, the operations of this step refer to, or may be performed by, an image processing apparatus as described with reference to FIG. 1.

In some cases, the noise map includes random noise. The noise map may be in a pixel space or a latent space. For example, the image processing apparatus samples a random noise including a mean and covariance initialized as zero and unit, respectively. By initializing a media item with random noise, different variations of a media item including the content described by the conditional guidance can be generated.

At operation 215, the system modifies the noise map based on the text prompt. In some cases, the operations of this step refer to, or may be performed by, an image processing apparatus as described with reference to FIG. 15.

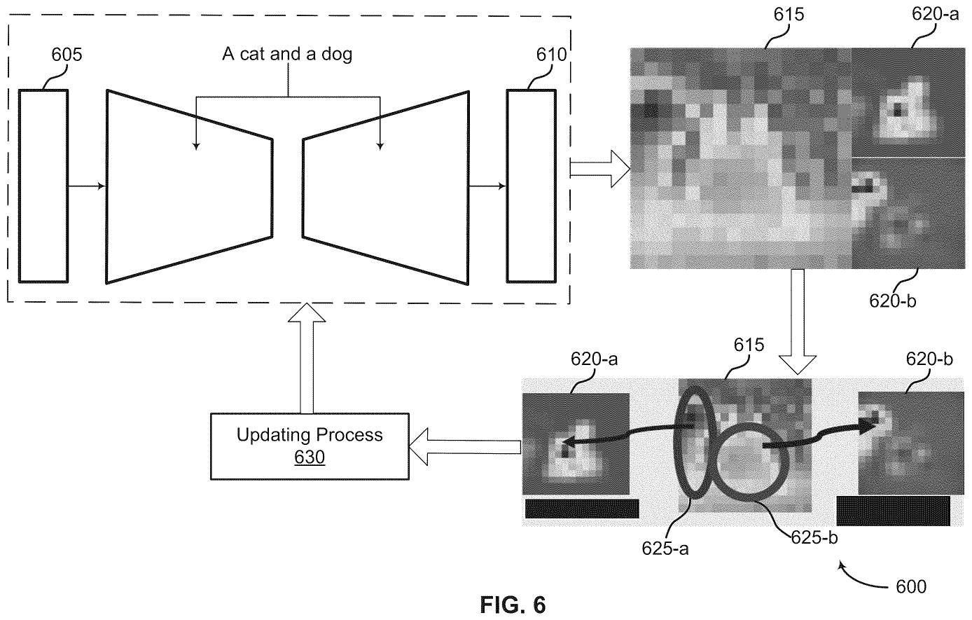

In some cases, the image processing apparatus performs a denoising step to generate a modified noise map based on optimizing the mean and the covariance. For example, the mean and the covariance are optimized using an attention contrast loss. In some examples, the attention contrast loss is generated by computing a weighted average of a distribution divergence term, an attention contrast term, and an attention complete term. Further details regarding the optimization process are provided with reference to at least FIGS. 6 and 9-11.

At operation 220, the system generates a synthetic image. In some cases, the operations of this step refer to, or may be performed by, an image processing apparatus as described with reference to FIG. 15. For example, the synthetic image is generated based on the modified noise map. For example, the synthetic image is generated using an image generation model as described with reference to at least FIGS. 4 and 9. The synthetic image is provided to the user via a user interface of the user device.

FIG. 3 shows an example of an image generation process 300 according to aspects of the present disclosure. In one aspect, image generation process 300 includes input prompt 305, image processing apparatus 310, and synthetic image 315.

Referring to FIG. 3, input prompt 305 describes aspects of an image a user (such as the user described with reference to FIGS. 1-2) wants to generate. For example, the user wants to generate an image with “A dolphin and turtle swimming in an ocean”. In some examples, the user provides input prompt 305 to image processing apparatus 310 via a user interface of the image processing apparatus 310. Input prompt 305 is an example of, or includes aspects of, the corresponding element described with reference to FIG. 4.

The image processing apparatus 310 (such as the image processing apparatus described with reference to FIGS. 1-2, 4, 9-11, and 15) of the present disclosure receives the input prompt 305 (such as input prompt described with reference to FIGS. 1-2) from the user. In some cases, the image processing apparatus 310 generates synthetic image 315 that matches aspects of the input prompt 305. For instance, the image processing apparatus 310 generates synthetic image 315 that accurately depicts “A dolphin and turtle swimming in an ocean” based on the input prompt 305. Image processing apparatus 310 is an example of, or includes aspects of, the corresponding element described with reference to FIG. 1. Synthetic image 315 is an example of, or includes aspects of, the corresponding element described with reference to FIG. 4.

FIG. 4 shows an example of an image generation model with an attention layer 400 according to aspects of the present disclosure.

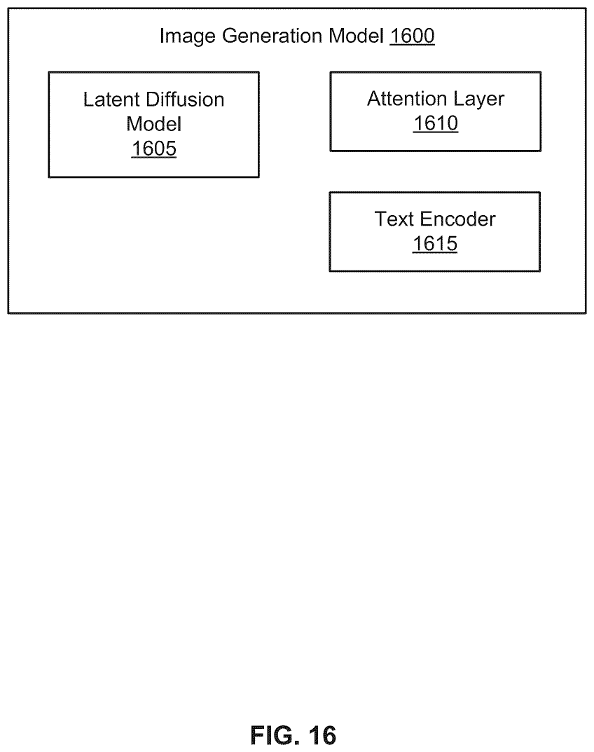

Attention layer 400 is an example of, or includes aspects of, the corresponding element described with reference to FIG. 16. In one aspect, attention layer 400 includes synthetic image 405, self-attention map 410, cross-attention map 415, and input prompt 420.

An embodiment of the present disclosure is configured to generate a synthetic image based on the attention information. As shown in FIG. 4, synthetic image 405 depicts “A dolphin and turtle swimming in an ocean” as described by the input prompt 420. For example, the synthetic image 405 depicts a first element (e.g., dolphin) and a second element (e.g., turtle) based on input prompt 420. For example, the image generation model implements a diffusion network (such as diffusion network described with reference to FIGS. 5-8) to generate synthetic image 405 and a corresponding self-attention map 410 and a cross-attention map 415 (i.e., comprising cross-attention map corresponding to a first element 415-a and cross-attention map corresponding to second element 415-b).

As shown in FIG. 4, the self-attention map 410 is indicative of the spatial location of the elements. In some examples, cross-attention map corresponding to first element 415-a and cross-attention map corresponding to second element 415-b are each indicating the spatial location of the first element and the second element, respectively as illustrated in synthetic image 405. Self-attention map 410 is an example of, or includes aspects of, the corresponding element described with reference to FIG. 6. Cross-attention maps 415-a and 415-b are examples of, or include aspects of, the corresponding element described with reference to FIG. 6.

Referring to FIG. 4, the image generation model is configured to prevent element neglect and element mixing. For example, the image generation model prevents element neglect by depicting each element (i.e., without missing an element) described in input prompt 420 at distinct locations in the synthetic image 405. Additionally, for example, the image generation model prevents element mixing by preventing mixing of element features (e.g., features such as fins or mouth of dolphin do not depict turtle-like texture). Synthetic image 405 is an example of, or includes aspects of, the corresponding element described with reference to FIG. 3. Input prompt 420 is an example of, or includes aspects of, the corresponding element described with reference to FIG. 3.

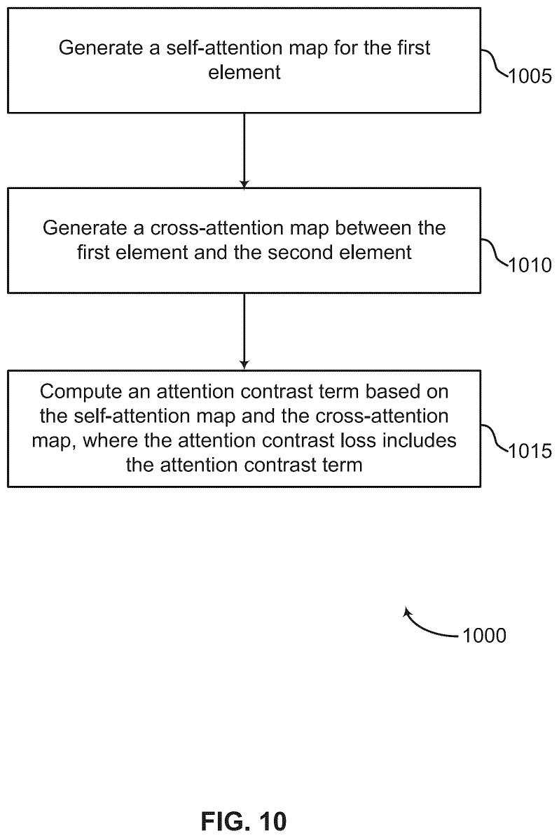

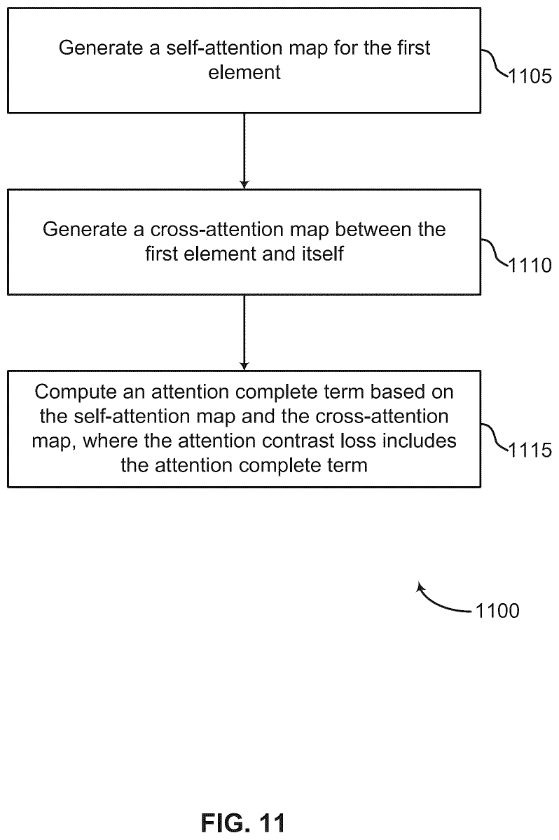

According to an embodiment of the present disclosure, the image generation model is used to optimize an initial latent noise that is subsequently denoised to generate the synthetic image. In some cases, the image generation model is configured to jointly use self-attention map (such as self-attention map 410) and cross-attention map (such as cross-attention maps 415-a and 415-b) to compute an attention contrast term (such as attention contrast term described with reference to FIG. 10) and an attention complete term (such as attention complete term described with reference to FIG. 11 and that is complementary to the attention contrast term).

The image generation model creates a mapping between the cross-attention map of each element and the corresponding segments obtained from the self-attention map, leading to an assignment of each self-attention segment to a particular element. In some cases, the attention complete term maximizes the cross-attention activation of each element within the assigned self-attention segment. In some cases, each element token includes a designated high-response segment in the self-attention map, thereby ensuring the presence of each element in the input prompt.

An embodiment of the present disclosure includes an image generation model configured to computes an attention contrast term. In some cases, the attention contrast term minimizes the overlap between the cross-attention map of an element and the self-attention segments of other elements which reduces an inter-subject confusion in the attention space. As a result, mixing of the features of elements in the synthetic image (e.g., synthetic image 405) is prevented.

As shown in FIG. 4, the image generation model comprising attention layer 400 depicts a segment each for dolphin and turtle. In some examples, the cross-attention map for dolphin (i.e., 415-a) and the cross-attention map for turtle (i.e., 415-b) only attend to the corresponding self-attention segments (i.e., as shown in self-attention map 410) which prevents an intermixing of features of the elements in the input prompt.

FIG. 5 shows an example of a guided diffusion model 500 according to aspects of the present disclosure. In some examples, guided diffusion model 500 describes the operation and architecture of the image generation model 1515 described with reference to FIG. 15 or image generation model 1600 described with reference to FIG. 16. The guided latent diffusion model 500 depicted in FIG. 5 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 500 may take an original media item 505 in a pixel space 510 as input and apply forward diffusion process 515 to gradually add noise to the original media item 505 to obtain noisy media item 520 at various noise levels.

Next, a reverse diffusion process 525 (e.g., a U-Net) gradually removes the noise from the noisy media item 520 at the various noise levels to obtain an output media item 530. In some cases, an output media item 530 is created from each of the various noise levels. The output media item 530 can be compared to the original media item 505 to train the reverse diffusion process 525.

The reverse diffusion process 525 can also be guided based on a text prompt 535, or another guidance prompt, such as an image, a layout, a segmentation map, etc. The text prompt 535 can be encoded using a text encoder 565 (e.g., a multimodal encoder) to obtain guidance features 545 in guidance space 550. The guidance features 545 can be combined with the noisy media item 520 at one or more layers of the reverse diffusion process 525 to ensure that the output media item 530 includes content described by the text prompt 535. For example, guidance features 545 can be combined with the noisy features using a cross-attention block within the reverse diffusion process 525.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 6-8, 13, and 16.

FIG. 6 shows an example of an image generation model according to aspects of the present disclosure. Image generation model 600 is an example of, or includes aspects of, the corresponding element described with reference to FIG. 15. In one aspect, image generation model 600 includes intermediate output 605, optimized intermediate output 610, self-attention map 615, cross-attention map 620, mapping information 625, and updating process 630. Intermediate output 605 is an example of, or includes aspects of, noisy media item 520 described with reference to FIG. 5.

An embodiment of the present disclosure includes image generation model configured to perform text-to-image synthesis. The image generation model implements loss functions that jointly use information from cross-attention map and self-attention map (such as cross-attention map and self-attention map described with reference to at least FIG. 4). In some cases, the image generation model optimizes intermediate output 605 (i.e., a latent noise) to generate optimized intermediate output 610 which is used as a starting point to generate a desired image output (e.g., in a denoising process as described in FIG. 5).

FIG. 6 shows the self-attention map 615 and cross-attention map 620 (e.g., cross-attention map associated with first element 620-a and cross-attention map associated with second element 620-b) for a partially denoised latent, i.e., denoised for one step. As shown in FIG. 6, the self-attention map 615 and cross-attention maps 620 (i.e., 620-a and 620-b) are indicative of the spatial location of the elements. In some cases, each of the self-attention map 615 and cross-attention maps 620 provide information related to the attention neglect and attention interference. Self-attention map 615 is an example of, or includes aspects of, the corresponding element described with reference to FIG. 4. Cross-attention map 620 is an example of, or includes aspects of, the corresponding element described with reference to FIG. 4.

The image generation model of the present disclosure is configured to compute an attention contrast loss using the self-attention map 615 and cross-attention maps 620 (i.e., 620-a and 620-b) based on a partially denoised latent. The attention contrast loss is used to optimize the initial latent which is subsequently denoised using a diffusion network (such as using denoising process in diffusion network described in FIG. 5) to generate a synthetic image (such as synthetic image 405 described with reference to at least FIG. 4). The image generation model ensures presence of each element of the input prompt and minimizes element mixing in the synthetic image.

Referring again to FIG. 6, cross-attention maps 620 (i.e., 620-a and 620-b) for any pair of elements include high-response regions and attend to different segments and/or elements in the self-attention map 615 or synthetic image. For example, cross-attention map 620-a uses mapping information 625-a for attending to a corresponding segment in self-attention map 615. Similarly, for example, cross-attention map 620-b uses mapping information 625-b for attending to a corresponding segment in self-attention map 615.

In some cases, the self-attention map 615 and the cross-attention maps (i.e., 620-a and 620-b) are indicative of the spatial location of the first element and the second element. In some cases, the number of (e.g., unique) segments in self-attention map 615 is equal to the number of elements provided by the input prompt. In some cases, there is no interference between high-response regions in the cross-attention map of an element and the self-attention regions corresponding to another element.

The image generation model is configured to randomly sample an initial latent code z_{T}˜ [symbol] (μ,σ), where (μ,σ) are the parameters to be updated as part of the optimization process. In some cases, the image generation model initializes the process as zero-mean and unit-covariance and performs one step of denoising to obtain z_{T-1}. Subsequently, the image generation model computes an attention contrast loss for given z_{T-1} and updates the (μ,σ) parameters. The image generation model updates the latent code based on the updated μ′ and σ′ values.

In some cases, the image generation model performs a one-step denoising with the image

$${z}_{T}^{′} ,$$

generation model generates the final optimized parameters (\hat{μ},\hat{σ}) that provide the optimized starting latent. The optimized starting latent is denoised using the diffusion network to generate a synthetic image that accurately aligns with the input prompt. Further details regarding the computation of the attention contrast loss and updating the latent code are provided with reference to FIGS. 9-11.

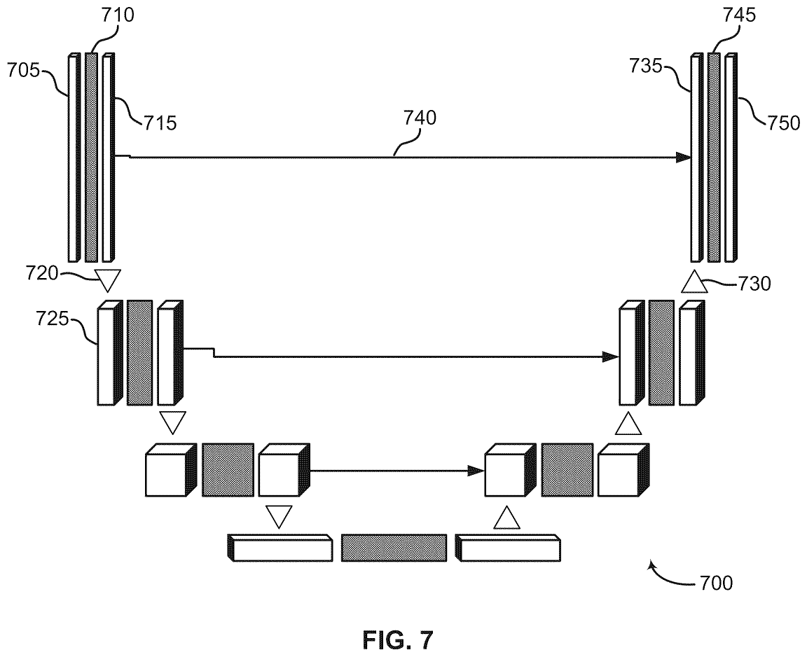

FIG. 7 shows an example of a U-Net 700 according to aspects of the present disclosure. In some examples, U-Net 700 is an example of the component that performs the reverse diffusion process 525 of guided diffusion model 500 described with reference to FIG. 5 and includes architectural elements of the image generation model 1515 described with reference to FIG. 15 or image generation model 1600 described with reference to FIG. 16. The U-Net 700 depicted in FIG. 7 is an example of, or includes aspects of, the architecture used within the reverse diffusion process described with reference to FIG. 5.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having the same resolution and number of channels via a skip connection 740. These inputs are processed using a final neural network layer 745 to produce output features 750. In some cases, the output features 750 have the same resolution as the initial resolution and the same number of channels as the initial number of channels.

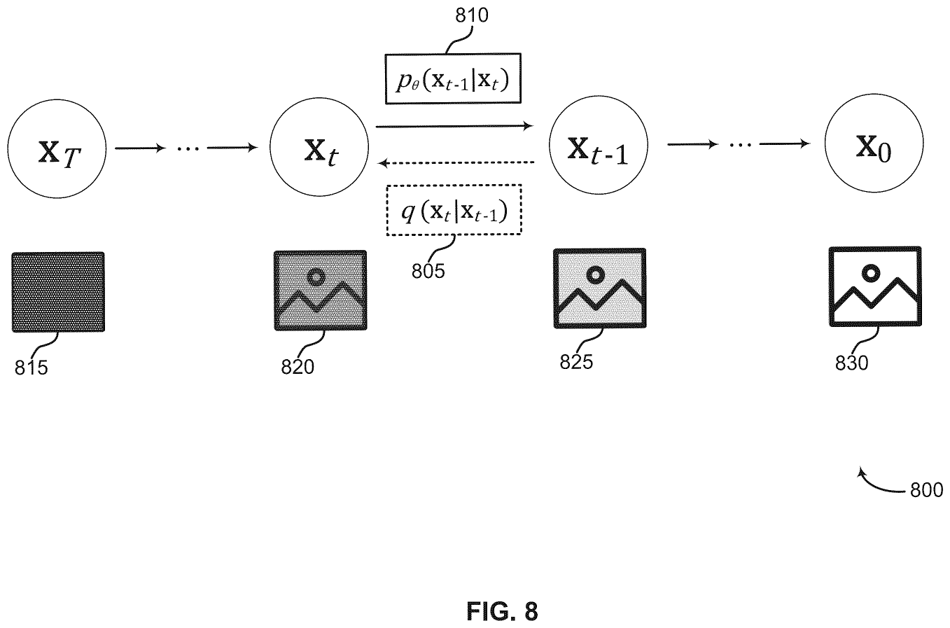

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715. U-Net architecture is an example of, or includes aspects of, the corresponding element described with reference to FIGS. 5 and 8.

FIG. 8 shows a diffusion process 800 according to aspects of the present disclosure. In some examples, diffusion process 800 describes an operation of the image generation model 1515 described with reference to FIG. 15 or image generation model 1600 described with reference to FIG. 16, such as the reverse diffusion process 525 of guided diffusion model 500 described with reference to FIG. 5.

As described above with reference to FIG. 5, using a diffusion model can involve both a forward diffusion process 805 for adding noise to a media item (or features in a latent space) and a reverse diffusion process 810 for denoising the media item (or features) to obtain a denoised media item. The forward diffusion process 805 can be represented as q(xₜ|xₜ₋₁), and the reverse diffusion process 810 can be represented as p(xₜ₋₁|xₜ). In some cases, the forward diffusion process 805 is used during training to generate media items with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data x_{T}, such as a noisy media item 815 and denoises the data to obtain the p(xₜ₋₁|xₜ). At each step t−1, the reverse diffusion process 810 takes xₜ, such as first intermediate media item 820, and t as input. Here, t represents a step in the sequence of transitions associated with different noise levels, The reverse diffusion process 810 outputs xₜ₋₁, such as second intermediate media item 825 iteratively until x_{T} reverts back to x₀, the original media item 830. The reverse process can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T};0,l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality. Diffusion process is an example of, or includes aspects of, the corresponding element described with reference to FIGS. 2, 5-7, 13, and 15-16.

Accordingly, an apparatus for image processing is described. One or more aspects of the apparatus include a memory component; a processing device coupled to the memory component, the processing device configured to perform operations comprising: obtaining an input prompt describing a first element and a second element; generating, using an image generation model, an intermediate output based on the input prompt; optimizing the intermediate output based on an attention contrast loss to obtain an optimized intermediate output, wherein the optimized intermediate output represents the first element at a first location and the second element at a second location; and generating, using the image generation model, a synthetic image based on the optimized intermediate output, wherein the synthetic image depicts the first element at the first location and the second element at the second location.

In some aspects, the image generation model includes an attention layer, and wherein the attention contrast loss is based on an output of the attention layer. In some aspects, the image generation model includes a latent diffusion model. In some aspects, a text encoder configured to encode the input prompt to obtain a text embedding.

### Image Generation Process

The present disclosure describes systems and methods for text-to-image generation. Embodiments of the present disclosure are configured to generate a synthetic image that accurately aligns with each aspect described by an input text prompt. In some cases, the synthetic image is generated by preventing an attention neglect and an attention interference.

For example, in case of the attention neglect, the synthetized image omits an element in the input prompt because the element does not have a designated segment in the self-attention map despite having a high-response cross-attention map. Additionally, for example, in case of the attention interference, the synthetized image has mixed-up properties of multiple elements because of a conflicting overlap between the cross-attention map and the self-attention map of different elements.

Embodiments of the present disclosure include an image generation model configured to optimize an intermediate output (e.g., an initial latent vector) by leveraging complementary information within a self-attention map and a cross-attention map corresponding to an input prompt. In some cases, the image generation model computes an attention contrast loss (e.g., a combined loss function) based on computing a weighted average of an attention contrast term (such as attention contrast term described in FIG. 10), an attention complete term (such as attention complete term described in FIG. 11), and a distribution divergence term (e.g., Kullback-Leibler divergence loss).

For example, the initial intermediate output (e.g., initial latent vector) is optimized based on the attention contrast loss to generate an optimized intermediate output (e.g., an optimized latent vector). In some examples, the image generation model comprises a diffusion model that denoises the optimized intermediate output to generate a synthetic image. The synthetic image is a meaningful image that is accurately aligned with the input prompt.

FIG. 9 shows an example of a method for image processing 900 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains an input prompt describing a first element and a second element. In some cases, the operations of this step refer to, or may be performed by, a user interface as described with reference to FIGS. 1-3 and 14-15.

For example, in some cases, the user interface of the image processing apparatus (such as image processing apparatus 1500 described with reference to FIG. 15) receives an input prompt from a user. In some examples, the input prompt is a text prompt that describes an element that the user wants to depict in the generated image (e.g., synthetic image). In some examples, the image processing apparatus receives the input prompt from a database or any other data source.

At operation 910, the system generates an intermediate output based on the input prompt. In some cases, the operations of this step refer to, or may be performed by, an image generation model as described with reference to FIG. 16.

The image generation model includes a latent diffusion model (such as diffusion model described with reference to FIGS. 5 and 7-8) and an attention layer (such as attention layer described with reference to FIGS. 4, 10-11, and 16). In some cases, the diffusion model comprises a latent encoder-decoder pair and a denoising diffusion probabilistic model (DDPM). In some cases, the encoder-decoder pair is a variational autoencoder where an image I∈R^{(w×H×3)} is mapped to an intermediate output (i.e., latent representation) z=E(I)∈R^{(h×w×c)} using E. In some cases, decoder D is trained to reconstruct I≈D(z).

A variational autoencoder (VAE) is a generative model that learns to represent data in a compressed latent space and generate new data samples. It consists of two key components: an encoder and a decoder. The encoder maps input data to a probabilistic latent space by learning a distribution over latent variables. Instead of directly mapping inputs to points in latent space, the encoder outputs parameters (mean and variance) of a Gaussian distribution, allowing the model to sample from this distribution to capture uncertainty. The decoder then reconstructs the original data by sampling from this latent space and mapping it back to the data space. The model is trained by minimizing a reconstruction loss, which measures how well the decoded data matches the input, and a Kullback-Leibler divergence term, which regularizes the learned latent space to be close to a standard normal distribution. The combination of these losses encourages the VAE to generate diverse, realistic data while maintaining smoothness in the latent space. VAEs are widely used for tasks such as image generation, data compression, and anomaly detection.

A DDPM is a generative model that synthesizes data by transforming random noise into structured outputs, such as images, through a two-step process: forward diffusion and reverse denoising. In the forward diffusion process, noise is incrementally added to input data over several steps, turning it into pure noise. Formally, each noisy sample xₜ is obtained by adding Gaussian noise to the previous step's sample xₜ₋₁. The process is controlled by a time-dependent variance schedule βₜ. In the reverse denoising process, the model removes the noise in a series of steps to recover the original data. The reverse process is learned via neural networks, which estimate the mean and variance of each step to reverse the diffusion and denoise the data. The model is trained to minimize the difference between the true data distribution and the model's predictions by optimizing the evidence lower bound (ELBO).

According to an embodiment, the DDPM operates in the z-space in a series of denoising steps. In each step t, given zₜ, the DDPM is trained to generate a denoised version zₜ₋₁. In case of text-to-image diffusion models, the DDPM is conditioned using text embeddings computed with a text encoder (such as text encoder 1615 described with reference to FIG. 16). For a representation L(p) of a given input prompt p, the DDPM ϵ_{θ} is trained to minimize:

$${E}_{( z E ( 1 ) , p , ϵ N ( 0 , 1 ) , t )} [ \vert ( \vert ϵ - {ϵ}_{θ} ( {z}_{t} , L ( p ) , t ) \vert ) \vert ] \qquad ( 3 )$$

At operation 915, the system optimizes the intermediate output based on an attention contrast loss to obtain an optimized intermediate output, where the optimized intermediate output represents the first element at a first location and the second element at a second location. In some cases, the operations of this step refer to, or may be performed by, an image generation model as described with reference to FIG. 16.

According to an embodiment of the present disclosure, text conditioning via cross-attention layers results in a set of cross-attention maps Aₜ∈R_{r×r×N} at each denoising step t for each of N tokens (i.e., N elements) in the input prompt p. In some cases, the image generation model of the present disclosure excludes the attention map of the [sot] token and normalizes the attention maps of other tokens which results in an aggregated cross-attention map A^{C}∈ [symbol] ^{r×r×n} (e.g., A^{C}∈ [symbol] ^{16×16×n}), containing n spatial cross-attention maps for each element token in the prompt.

In some examples, the image generation model aggregates self-attention map across each layer which provides information related to each pixel in a 16×16 map attending to each of the other pixels. The self-attention maps are denoted as A^{S}∈ [symbol] ^{r×r×n} (e.g., A^{S}∈ [symbol] ^{16×16×256}). In some cases, the image generation model generates an overall cross-attention map by computing an average of the cross-attention maps across each layer and head at a 16×16 resolution.

In some cases, based on the cross-attention maps and the self-attention maps, the image generation model computes a cost function C:

$$C ( i , j ) = {\sum }_{k = 1}^{r} {\sum }_{l = 1}^{r} {[ {A}_{i}^{s} * {A}_{j}^{c} ]}_{k , l} \qquad ( 4 )$$

where * denotes element-wise multiplication. C(i,j) denotes the intersection between the i^{th} self-attention segment

$${A}_{i}^{s}$$

and the j^{th} cross-attention map

$${A}_{j}^{c}$$

where i,j∈[1,n]. The matrix C represents the intersection values between each pair of self-attention segments and cross-attention maps.

Additionally, for a given cost function C, the image generation model determines an optimal permutation matrix \hat{P} such that Tr(PC) is maximized, where Tr(·) denotes the trace of matrix. In some examples, the trace computation maximizes the intersection between the self-attention segments in A^{S} and the cross-attention maps in A^{C}.

Each element token corresponds to a row in permutation matrix \hat{P} that represents the self-attention segment the token is mapped to (e.g., the element token includes 1 and the remaining elements in the row are zeros) after optimization. For example, the first row in permutation matrix \hat{P} with values such as (0,0,1,0) indicates that the first element is mapped to the third self-attention segment. The permutation matrix \hat{P} and the cost function C are used to compute an attention contrast term [symbol] _{Acont} and an attention complete term [symbol] _{Acomp}. Further details regarding computation of the attention contrast term [symbol] _{Acont} and the attention complete term [symbol] _{Acomp} are provided with reference to FIGS. 10-11.

An embodiment of the present disclosure is configured to compute a Kullback-Leibler (KL) divergence loss. In some cases, the KL loss is computed to ensure the distribution of the optimized latent is close to the standard normal distribution: [symbol] _{KL}=KL( [symbol] (μ,σ²)∥ [symbol] (0,1)). The attention contrast loss (i.e., combined loss function or overall objective function) is computed as:

$$ℒ = {λ}_{I} {ℒ}_{Acont} + {λ}_{2} {ℒ}_{Acomp} + {λ}_{3} {ℒ}_{KL} \qquad ( 5 )$$

where λ₁=1, λ₂=1, λ₃=500 are set empirically.

In some cases, the image generation model randomly samples an intermediate output (i.e., an initial latent code) z_{T}˜ [symbol] (μ,σ), initializes zero-mean and unit-covariance, and performs one-step denoising (such as denoising described in FIG. 5) to obtain z_{T-1}. The image generation model modifies the denoised latent code (z_{T-1}) and updates the mean and covariance (i.e., μ,σ) parameters based on the attention contrast loss:

$${μ}^{l} = μ + {∇}_{μ} ℒ \qquad ( 6 )$$

$${σ}^{′} = σ + {∇}_{σ} ℒ$$

The image generation model updates the intermediate output (e.g., latent code) based on the updated μ′ and σ′ values.

$${z}_{T}^{′} = {μ}^{′} + {σ}^{′} {z}_{T - 1} \qquad ( 7 )$$

In some cases, the image generation model performs a one-step denoising with updated

$${z}_{T}^{′} ,$$

updates the (μ,σ) parameters, and the process is repeated until convergence to generate final optimized parameters.

At operation 920, the system generates a synthetic image based on the optimized intermediate output, where the synthetic image depicts the first element at the first location and the second element at the second location. In some cases, the operations of this step refer to, or may be performed by, an image generation model as described with reference to FIG. 16.

The image generation model generates the final optimized parameters (\hat{μ},\hat{σ}) that provide the optimized intermediate output (e.g., optimized starting latent). The final optimized parameters are denoised to generate a synthetic image that accurately aligns with the input prompt. In some cases, at test (e.g., inference) time, for a given input prompt representation L(p), an image is synthesized by repeatedly denoising the optimized latent code

$${z}_{T}^{′} ∼ 𝒩 ( \hat{μ} , \hat{σ} )$$

in T steps. Subsequently, the denoised latent is decoded using D to generate the synthetic image I.

For example, the image generation model generates the synthetic image that depicts each of the elements indicated by the input prompt. In some cases, the image is generated via a reverse diffusion process based on the optimized latent code as described with reference to FIGS. 5-6 and 10-11. In some cases, the image generation model provides the synthetic image to the user via the user interface (such as the user interface described with reference to at least FIGS. 1-3).

An embodiment of the present disclosure includes an image generation model configured to identify an attention neglect and an attention interference during a text-to-image generation process. In some cases, the attention neglect and the attention interference leads to missing elements and mixing of different elements, respectively, in a synthesized image. The image generation model is configured to optimize an initial latent noise to generate optimized latent noise based on computing an attention contrast loss. The optimized latent noise is subsequently denoised to generate the synthetic image.

According to an embodiment of the present disclosure, the image generation model computes the attention contrast loss based on computing a weighted average of an attention contrast term, an attention complete term, and a distribution divergence term (e.g., Kullback-Leibler divergence loss). In some cases, the attention contrast term is used to minimize undesirable overlap by ensuring each self-attention segment is exclusively linked to a cross attention map of a specific element.

FIG. 10 shows an example of a method for computing attention contrast term 1000 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system generates a self-attention map for the first element. In some cases, the operations of this step refer to, or may be performed by, a user interface as described with reference to FIGS. 1-3 and 14-15.

The image generation model computes the self-attention maps and determines the first principal component for a given latent code z at an iteration. The self-attention maps are then sigmoid softened as A=(σ(A−β)), where A is the self-attention map, σ( ) is the sigmoid function, and α=16, β=0.5 are scalars. The self-attention maps are sigmoid softened to exclude low response regions and increase the importance of high-response regions.

The image generation model separates the high-response regions to get n distinct segments, one corresponding to each subject (e.g., element), for an input prompt comprising n subjects. In some cases, A^{s}∈ [symbol] ^{r×r×n} denotes the matrix representing the n segments (

$${A}_{i}^{s}$$

refers to the i^{th} segment). In some cases, A includes less than n segments (e.g., u<n). In some cases, the image generation model generates n−u zero-element matrices (of dimensions r×r) such that there are n segments in total. In some cases, the zero-element matrices represent subjects that are omitted by the image generation model.

At operation 1010, the system generates a cross-attention map between the first element and the second element. In some cases, the operations of this step refer to, or may be performed by, an image generation model as described with reference to FIG. 16.

The image generation model computes the cross-attention maps corresponding to the n subject tokens. The cross-attention map is denoted as A^{c}∈ [symbol] ^{r×r×n}. In some cases, the image generation model assigns each segment in the self-attention map to a distinct cross-attention map resulting in a one-to-one mapping. For example, an assignment optimization operation is used to compute the mapping. In some examples, the assignment optimization operation determines an optimal permutation matrix \hat{P} for a given cost function C, such that Tr(PC) is maximized, where Tr(·) denotes trace of the matrix.

Accordingly, the image generation model maximizes the intersection between the self-attention segments in A^{s} and the cross-attention maps in A^{c}. The cost function matrix C is computed as described in Equation 4. The matrix C then represents intersection values between each possible pair of self-attention segments and cross-attention maps.

In some cases, each subject token has a corresponding row in the optimal permutation matrix P that represents the self-attention segment the subject token is mapped to after optimization. For example, the entry in the matrix is represented as 1, remaining elements in the row are zeros. In some examples, a first row in the optimal permutation matrix \hat{P} with values as (0,0,1,0) indicates that the first subject is mapped to the third self-attention segment. The optimal permutation matrix \hat{P} is used to compute the attention contrast term.

At operation 1015, the system computes an attention contrast term based on the self-attention map and the cross-attention map, where the attention contrast loss includes the attention contrast term. In some cases, the operations of this step refer to, or may be performed by, an image generation model as described with reference to FIG. 16.

In some cases, attention contrast term is used to minimize interference between the high-response regions in the cross-attention map of a subject with segments of other subjects in the self-attention map. For example, each zero-element entry of the optimal permutation matrix \hat{P} corresponds to an undesired mapping between the cross-attention map of a subject and the self-attention segment of another subject. The image generation model obtains the said zero-element entries from the cost function matrix C. Additionally, the image generation model minimizes the resulting overall intersection value which minimizes the interference.

The intersection value is minimized using the attention contrast term as:

$${ℒ}_{Acont} = {\sum }_{i , j , i \neq j} ( \frac{{[ \hat{P} ⊗ C ]}_{i , j}}{{\sum }_{k = 1}^{r} {\sum }_{l = 1}^{r} {A}_{i}^{s} ( k , l )} ) \qquad ( 8 )$$

where ⊗ refers to the matrix multiplication operation. In some cases, \vec{P}⊗C for i≠j (i.e., off-diagonal elements) provides the undesired intersection values.

According to an embodiment of the present disclosure, the image generation model computes an attention contrast loss based on computing a weighted average of an attention contrast term, an attention complete term, and a distribution divergence term (e.g., Kullback-Leibler divergence loss). In some cases, the attention complete term is used to maximize the activation within the self-attention segments of each element to guarantee that each element is fully and distinctly represented.

FIG. 11 shows an example of a method for computing attention complete term 1100 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system generates a self-attention map for the first element. In some cases, the operations of this step refer to, or may be performed by, a user interface as described with reference to FIGS. 1-3 and 14-15.

The image generation model computes the self-attention maps and determines the first principal component for a given latent code z at an iteration. The self-attention maps are then sigmoid softened as A=σ(α(A−β)), where A is the self-attention map, σ( ) is the sigmoid function, and α=16, β=0.5 are scalars. The self-attention maps are sigmoid softened to exclude low response regions and increase the importance of high-response regions.

The image generation model separates the high-response regions to get n distinct segments, one corresponding to each subject, for an input prompt comprising n subjects. Let A^{s}∈ [symbol] ^{r×r×n} denote the matrix representing the n segments (

$${A}_{i}^{s}$$

refers to the i^{th} segment). In some cases, A includes less than n segments (e.g., u<n). In some cases, the image generation model generates n−u zero-element matrices (of dimensions r×r) such that there are n segments in total. In some cases, the image generation model omits the zero-element matrices that represent subjects.

At operation 1110, the system generates a cross-attention map between the first element and itself. In some cases, the operations of this step refer to, or may be performed by, an image generation model as described with reference to FIG. 16.

The image generation model computes the cross-attention maps corresponding to the n subject tokens. The cross-attention map is denoted as A^{c}∈ [symbol] ^{r×r×n}. In some cases, the image generation model assigns each segment in the self-attention map to a distinct cross-attention map resulting in a one-to-one mapping. For example, an assignment optimization operation is used to compute the mapping. In some examples, the assignment optimization operation determines an optimal permutation matrix \hat{P} for a given cost function C, such that Tr(PC) is maximized, where Tr(·) denotes trace of the matrix.

Accordingly, the image generation model maximizes the intersection between the self-attention segments in A^{s} and the cross-attention maps in A^{c}. The cost function matrix C is computed as described in Equation 4. The matrix C then represents intersection values between each possible pair of self-attention segments and cross-attention maps.

In some cases, each subject token has a corresponding row in the optimal permutation matrix \hat{P} that represents the self-attention segment the subject token is mapped to after optimization. For example, the entry in the matrix is represented as 1, remaining elements in the row are zeros. In some examples, a first row in the optimal permutation matrix \hat{P} with values as (0,0,1,0) indicates that the first subject got mapped to the third self-attention segment. The optimal permutation matrix \hat{P} is used to compute the attention complete term.

At operation 1115, the system computes an attention complete term based on the self-attention map and the cross-attention map, where the attention contrast loss includes the attention complete term. In some cases, the operations of this step refer to, or may be performed by, an image generation model as described with reference to FIG. 16.

In some cases, the image generation model ensures the cross-attention map of each element has a designated and unique high-response segment in the self-attention map. Accordingly, each self-attention map includes n complete segments such that each segment has a high overlap with the cross-attention map of a corresponding element. In some examples, a missing segment is set to zero matrix. In some examples, non-zero values are included in the zero matrix that represent the presence of a segment.

The image generation model considers the diagonal elements in the matrix \hat{P}⊗C. In some cases, the image generation model determines the element with the least/minimum overlap or intersection value. Subsequently, the image generation model maximizes the element with the least/minimum overlap or intersection value based on computing the attention complete term as:

$${ℒ}_{Acont} = 1 - {min}_{i} ( \frac{{[ \hat{P} ⊗ C ]}_{i , i}}{{\sum }_{k = 1}^{r} {\sum }_{l = 1}^{r} {A}_{i}^{s} ( k , l )} ) \qquad ( 9 )$$

In some examples, when a synthesized image has missing elements (such as an element of the input prompt missing in the synthetized image), the minimum value is zero, resulting in a high loss, i.e., loss value of 1. The loss value of 1 indicates a missing element. In some cases, the image generation model of the present disclosure minimizes the loss which prevents missing of elements in the synthetic image (such as synthetic image described with reference to FIGS. 1-3). In some cases, a high value of the minimum overlap is obtained.

Accordingly, a method for image processing is described. One or more aspects of the method include obtaining an input prompt describing a first element and a second element; generating, using an image generation model, an intermediate output based on the input prompt; optimizing the intermediate output based on an attention contrast loss to obtain an optimized intermediate output, wherein the optimized intermediate output represents the first element at a first location and the second element at a second location; and generating, using the image generation model, a synthetic image based on the optimized intermediate output, wherein the synthetic image depicts the first element at the first location and the second element at the second location.

Some examples of the method, apparatus, and non-transitory computer readable medium further include encoding the input prompt to obtain a text embedding, wherein the intermediate output is based on the text embedding. Some examples of the method, apparatus, and non-transitory computer readable medium further include optimizing the intermediate output comprises: updating a mean and a covariance of the intermediate output.

Some examples of the method, apparatus, and non-transitory computer readable medium further include optimizing the intermediate output comprises: generating a self-attention map for the first element; generating a cross-attention map between the first element and the second element; and computing an attention contrast term based on the self-attention map and the cross-attention map, wherein the attention contrast loss includes the attention contrast term.

Some examples of the method, apparatus, and non-transitory computer readable medium further include optimizing the intermediate output comprises: generating a self-attention map for the first element; generating a cross-attention map between the first element and itself; and computing an attention complete term based on the self-attention map and the cross-attention map, wherein the attention contrast loss includes the attention complete term.

Some examples of the method, apparatus, and non-transitory computer readable medium further include optimizing the intermediate output comprises: computing a distribution divergence term, wherein the attention contrast loss includes the distribution divergence term. Some examples of the method, apparatus, and non-transitory computer readable medium further include generating the synthetic image comprises: denoising the intermediate output.

### Training

The present disclosure describes systems and methods of image generation based on an input prompt. Embodiments of the present disclosure include an image generation model configured to identify attention neglect and attention interference for optimizing an initial latent code. In some examples, the attention neglect and the attention interference result in element neglect and element mixing. The image generation model implements a reverse diffusion process to denoise the optimized latent code (as described in FIGS. 5-6 and 9-11) for generating a synthetic image that accurately aligns with aspects of the input prompt.

In some cases, the image generation model is configured to compute an attention contrast loss including an attention contrast term and an attention complete term. For example, the attention contrast term ensures no overlap between cross-attention maps of one element with self-attention segments of other elements. For example, the attention complete term ensures each element in the input prompt has a designated self-attention segment.

FIG. 12 shows an example of a method of training a machine learning model according to aspects of the present disclosure. FIG. 12 is a flow diagram depicting an algorithm as a step-by-step procedure 1200 in an example implementation of operations performable for training a machine-learning model. In some embodiments, the procedure 1200 describes an operation of the training component 1525 described for configuring the image generation model 1515 as described with reference to FIG. 15. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model. The machine learning model, is an example of, or includes aspects of, the image generation model described with reference to FIGS. 1-4, 6, 13, and 15-16.

FIG. 13 shows an example of a method of training a diffusion model 1300 according to aspects of the present disclosure. In some embodiments, the method 1300 describes an operation of the training component 1525 described for configuring the image generation model 1515 as described with reference to FIG. 15. The method 1300 represents an example for training a reverse diffusion process as described above with reference to FIGS. 5 and 7-8. In some examples, these operations are performed by a system including a processor executing a set of codes to control functional elements of an apparatus, such as the guided diffusion model described in FIG. 5.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 13, according to some aspects, a training component (such as the training component 1525 described with reference to FIG. 15) trains a diffusion model (such as the image generation model described with reference to FIGS. 4-8) to generate an output.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image (or an additional training image) using a forward diffusion process (such as the forward diffusion process described with reference to FIG. 5) in N stages. In some cases, the operations of this step refer to, or may be performed by, a training component as described with reference to FIG. 15.

At operation 1315, the system at each stage n, starting with stage N, a reverse diffusion process is used to predict the output or features at stage n-1. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1325, the system updates parameters of the model based on the comparison. For example, parameters of a U-Net may be updated using gradient descent. Time-dependent parameters of the Gaussian transitions can also be learned.

### Implementation and Evaluation

An exemplary embodiment of the present disclosure is configured to evaluate a performance of an image generation model of the present disclosure using standard evaluation metrics. In some cases, the image generation model significantly outperforms the existing methods. In some examples, the image generation model includes Stable Diffusion v2.1 as the base model. For example, the image generation model is evaluated on benchmark text-to-image datasets and complex prompts curated using a transformer network.

According to an example, the image generation model is able to prevent element neglect and element mixing across the generated synthetic images. For example, the synthetic image generated by the image generation model does not miss an element provided by the input prompt, e.g., the image generation model clearly depicts each of the dolphin and turtle provided by the input prompt (as shown in FIGS. 1-3). Additionally, for example, the synthetic image generated by the image generation model does not mix features of different elements provided by the input prompt, e.g., the image generation model does not mix fins or face of the dolphin and turtle provided by the input prompt (as shown in FIGS. 1-3).

In some examples, the image generation model is evaluated using text-to-image evaluation metric and text-text similarity scores. For example, the image generation model generates 64 images with randomly selected seeds and reports results averaged across each generation for each input prompt. The image generation model is able to ensure each element from the prompt has a designated self-attention segment via the attention complete term (as described in FIGS. 4, 6, and 11) resulting in prevention of element neglect (or missing).

Additionally, the image generation model incorporates the attention contrast term resulting in the synthetic image accurately depicting features of each element. In some examples, the attention contrast term (as described in FIGS. 4, 6, and 10) minimizes the interference between the cross-attention map of an element with the self-attention segment of another element. For example, the image generation model generates 64 images for each input prompt using the attention complete term and the attention contrast term and computes averaged image-text and text-text similarity scores. In some examples, human users prefer synthetic image generated by the image generation model of the present disclosure over images synthesized by existing methods.

### Computing Device

FIG. 14 shows an example of a computing device according to aspects of the present disclosure. The computing device 1400 may be an example of the image processing apparatus 1500 described with reference to FIG. 15. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the image generation model of FIGS. 15-16. In some embodiments, computing device 1400 includes one or more processors 1405 that can execute instructions stored in memory subsystem 1410 to perform media generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of an image processing apparatus 1500 according to aspects of the present disclosure. Image processing apparatus 1500 is an example of, or includes aspects of, the corresponding element described with reference to FIGS. 1 and 3. According to some aspects, image processing apparatus 1500 obtains an input prompt indicating an image element (e.g., a first element and a second element).

In one aspect, image processing apparatus 1500 includes processor unit 1505, memory unit 1510, I/O module 1520, and training component 1525. Training component 1525 updates parameters of the image generation model 1515 stored in memory unit 1510. In some examples, the training component 1525 is located outside the image processing apparatus 1500.

According to some aspects, processor unit 1505 comprises a processing device coupled to the memory component. Processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1505 is configured to operate a memory array using a memory controller. In other cases, a memory controller is integrated into processor unit 1505. In some cases, processor unit 1505 is configured to execute computer-readable instructions stored in memory unit 1510 to perform various functions. In some aspects, processor unit 1505 includes special purpose components for modem processing, baseband processing, digital signal processing, or transmission processing. According to some aspects, processor unit 1505 comprises one or more processors described with reference to FIG. 14.

Memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1505 to perform various functions described herein.

In some cases, memory unit 1510 includes a basic input/output system (BIOS) that controls basic hardware or software operations, such as an interaction with peripheral components or devices. In some cases, memory unit 1510 includes a memory controller that operates memory cells of memory unit 1510. For example, the memory controller may include a row decoder, column decoder, or both. In some cases, memory cells within memory unit 1510 store information in the form of a logical state. According to some aspects, memory unit 1510 is an example of the memory subsystem 1410 described with reference to FIG. 14.

According to some aspects, image processing apparatus 1500 uses one or more processors of processor unit 1505 to execute instructions stored in memory unit 1510 to perform functions described herein. For example, the image processing apparatus 1500 may obtain an input prompt describing a first element and a second element; generate, using an image generation model, an intermediate output based on the input prompt; optimize the intermediate output based on an attention contrast loss to obtain an optimized intermediate output, wherein the optimized intermediate output represents the first element at a first location and the second element at a second location; and generate, using the image generation model, a synthetic image based on the optimized intermediate output, wherein the synthetic image depicts the first element at the first location and the second element at the second location.

In one aspect, memory unit 1510 includes image generation model 1515 trained to obtain an input prompt describing a first element and a second element; generate, using an image generation model, an intermediate output based on the input prompt; optimize the intermediate output based on an attention contrast loss to obtain an optimized intermediate output, wherein the optimized intermediate output represents the first element at a first location and the second element at a second location; and generate, using the image generation model, a synthetic image based on the optimized intermediate output, wherein the synthetic image depicts the first element at the first location and the second element at the second location.

For example, after training, the image generation model 1515 may perform inferencing operations as described with reference to FIGS. 1-3 to obtain an input prompt describing a first element and a second element; generate, using an image generation model, an intermediate output based on the input prompt; optimize the intermediate output based on an attention contrast loss to obtain an optimized intermediate output, wherein the optimized intermediate output represents the first element at a first location and the second element at a second location; and generate, using the image generation model, a synthetic image based on the optimized intermediate output, wherein the synthetic image depicts the first element at the first location and the second element at the second location.

Image generation model 1515 is an example of, or includes aspects of, the corresponding element described with reference to FIGS. 3-4. In some embodiments, the image generation model 1515 is an Artificial neural network (ANN) comprising a plurality of networks including the guided diffusion model described with reference to FIG. 5 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1525 may train the image generation model 1515. For example, parameters of the image generation model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 12-13). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1515 can be used to make predictions on new, unseen data (i.e., during inference).

FIG. 16 shows an example of a machine learning model according to aspects of the present disclosure.

According to some aspects, image generation model 1600 generates an intermediate output based on the input prompt. In some examples, image generation model 1600 optimizes the intermediate output based on an attention contrast loss to obtain an optimized intermediate output, where the optimized intermediate output represents the first element at a first location and the second element at a second location. In some examples, image generation model 1600 generates a synthetic image based on the optimized intermediate output, where the synthetic image depicts the first element at the first location and the second element at the second location.

In some examples, image generation model 1600 optimizes the intermediate output including updating a mean and a covariance of the intermediate output. In some examples, image generation model 1600 optimizes the intermediate output including generating a self-attention map for the first element; generating a cross-attention map between the first element and the second element; and computing an attention contrast term based on the self-attention map and the cross-attention map, where the attention contrast loss includes the attention contrast term.

In some examples, image generation model 1600 optimizes the intermediate output including generating a self-attention map for the first element; generating a cross-attention map between the first element and itself; and computing an attention complete term based on the self-attention map and the cross-attention map, where the attention contrast loss includes the attention complete term. In some examples, image generation model 1600 optimizes the intermediate output including computing a distribution divergence term, where the attention contrast loss includes the distribution divergence term. In some examples, image generation model 1600 generates the synthetic image including denoising the intermediate output.

According to some aspects, image generation model 1600 generates an intermediate output based on the input prompt. In some examples, image generation model 1600 optimizes the intermediate output based on an attention contrast loss to obtain an optimized intermediate output, where the attention contrast loss includes an attention contrast term and an attention complete term. In some examples, image generation model 1600 generates a synthetic image based on the optimized intermediate output.

In one aspect, image generation model 1600 includes latent diffusion model 1605, attention layer 1610, and text encoder 1615. Attention layer 1610 is an example of, or includes aspects of, the corresponding element described with reference to FIG. 4. According to some aspects, text encoder 1615 encodes the input prompt to obtain a text embedding, where the intermediate output is based on the text embedding.

In some cases, an attention layer may refer to a self-attention mechanism and/or a cross-attention mechanism. A self-attention mechanism enables a network to weigh input elements selectively (e.g., based on a relevance to other elements), emphasizing important features during computation. The self-attention mechanism incorporates dynamic attention scores, optimizing information processing. Additionally, a cross-attention mechanism facilitates effective interaction between different input sequences in neural network architectures by dynamically assigning attention scores based on their relevance. The cross-attention mechanism enhances model performance by providing for the network to focus on key features from one sequence while processing another, enabling more nuanced and context-aware information processing.

The self-attention mechanism provides for each pixel or patch of an image to attend to each of the other pixels or patches. The process involves generating query, key, and value vectors for each pixel or patch. The query from a given pixel is compared to the keys from each of the other pixels to compute an attention score, which indicates the relevance of each pixel in relation to the current one. These attention scores are then used to compute a weighted sum of the value vectors, producing a contextualized representation of the image. The mechanism provides for the model to capture long-range dependencies within an image, such as relating distant pixels that may belong to the same element or share important features. Self-attention is beneficial in tasks like element detection and segmentation, where spatial relationships and context across the entire image are crucial for accurate interpretation.

The cross-attention mechanism operates across two distinct image representations. In the cross-attention mechanism, one image representation (or feature map) generates query vectors, while the other representation generates the corresponding key and value vectors. The attention scores are computed by comparing the queries from one image (or region) with the keys from the other image (or modality). The attention scores are used to aggregate information from the second image (or modality), providing the first image representation with relevant, context-specific information from the second input. The cross-attention mechanism is particularly useful in multi-modal tasks like image captioning or image-text retrieval, where features from an image must align with textual descriptions or where multiple images are being compared or fused for better feature extraction and enhancement. Cross-attention enhances information integration across disparate inputs.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing a first element and a second element;
generating, using an image generation model, an intermediate output based on the input prompt;
optimizing the intermediate output based on an attention contrast loss to obtain an optimized intermediate output, wherein the optimized intermediate output represents the first element at a first location and the second element at a second location; and
generating, using the image generation model, a synthetic image based on the optimized intermediate output, wherein the synthetic image depicts the first element at the first location and the second element at the second location.

2. The method of claim 1, further comprising:
encoding the input prompt to obtain a text embedding, wherein the intermediate output is based on the text embedding.

3. The method of claim 1, wherein optimizing the intermediate output comprises:
updating a mean and a covariance of the intermediate output.

4. The method of claim 1, wherein optimizing the intermediate output comprises:
generating a self-attention map for the first element;
generating a cross-attention map between the first element and the second element; and
computing an attention contrast term based on the self-attention map and the cross-attention map, wherein the attention contrast loss includes the attention contrast term.

5. The method of claim 1, wherein optimizing the intermediate output comprises:
generating a self-attention map for the first element;
generating a cross-attention map between the first element and itself; and
computing an attention complete term based on the self-attention map and the cross-attention map, wherein the attention contrast loss includes the attention complete term.

6. The method of claim 1, wherein optimizing the intermediate output comprises:
computing a distribution divergence term, wherein the attention contrast loss includes the distribution divergence term.

7. The method of claim 1, wherein generating the synthetic image comprises:
denoising the intermediate output.

8. A non-transitory computer readable medium storing code, the code comprising instructions that, when executed by at least one processor, cause the at least one processor to perform operations comprising:
obtaining an input prompt indicating a first element and a second element;
generating, using an image generation model, an intermediate output based on the input prompt;
updating a statistical property of the intermediate output to obtain an optimized intermediate output, wherein the optimized intermediate output represents the first element and the second element; and
generating, using the image generation model, a synthetic image depicting the first element and the second element based on the optimized intermediate output.

9. The non-transitory computer readable medium of claim 8, the code further comprising instructions that, when executed by the at least one processor, cause the at least one processor to perform operations comprising:
encoding the input prompt to obtain a text embedding, wherein the intermediate output is based on the text embedding.

10. The non-transitory computer readable medium of claim 8, wherein:
the intermediate output is optimized based on an attention contrast loss to obtain the optimized intermediate output.

11. The non-transitory computer readable medium of claim 8, wherein updating the statistical property comprises:
generating a self-attention map for the first element;
generating a cross-attention map between the first element and the second element; and
computing an attention contrast term based on the self-attention map and the cross-attention map, wherein the attention contrast loss includes the attention contrast term.

12. The non-transitory computer readable medium of claim 8, wherein updating the statistical property comprises:
generating a self-attention map for the first element;
generating a cross-attention map between the first element and itself; and
computing an attention complete term based on the self-attention map and the cross-attention map, wherein the attention contrast loss includes the attention complete term.

13. The non-transitory computer readable medium of claim 8, wherein updating the statistical property comprises:
computing a distribution divergence term.

14. The non-transitory computer readable medium of claim 8, wherein generating the synthetic image comprises:
denoising the intermediate output.

15. A system comprising:
a memory component; and
a processing device coupled to the memory component, the processing device configured to perform operations comprising:
obtaining an input prompt describing a first element and a second element;
generating, using an image generation model, an intermediate output based on the input prompt;
optimizing the intermediate output based on an attention contrast loss to obtain an optimized intermediate output, wherein the optimized intermediate output represents the first element at a first location and the second element at a second location; and
generating, using the image generation model, a synthetic image based on the optimized intermediate output, wherein the synthetic image depicts the first element at the first location and the second element at the second location.

16. The system of claim 15, wherein:
the image generation model includes an attention layer, and wherein the attention contrast loss is based on an output of the attention layer.

17. The system of claim 15, wherein:
the image generation model includes a latent diffusion model.

18. The system of claim 15, further comprising:
a text encoder configured to encode the input prompt to obtain a text embedding.

19. The system of claim 15, wherein optimizing the intermediate output comprises:
generating a self-attention map for the first element;
generating a cross-attention map between the first element and the second element; and
computing an attention contrast term based on the self-attention map and the cross-attention map, wherein the attention contrast loss includes the attention contrast term.

20. The system of claim 15, wherein optimizing the intermediate output comprises:
generating a self-attention map for the first element;
generating a cross-attention map between the first element and itself; and
computing an attention complete term based on the self-attention map and the cross-attention map, wherein the attention contrast loss includes the attention complete term.
